(19) United States
(12) Patent Application Publication
(10) Pub. No.: US 2026/0370134 A1
(43) Pub. Date: Nov. 19, 2026

(54) SEMICONDUCTOR DEVICE, ISOLATED DC/DC CONVERTER, AC/DC CONVERTER, AND VEHICLE

(71) Applicant: ROHM CO., LTD., Kyoto (JP)

(72) Inventors: Yoshinori SATO, Kyoto (JP); Natsuki YAMAMOTO, Kyoto (JP)

(21) Appl. No.: 19/572,287

(22) Filed: Mar. 19, 2026

(30) Foreign Application Priority Data
Mar. 26, 2025 (JP) 2025-051584

(51) Int. Cl. H02M 1/36; H02M 1/08; H02M 3/335

(52) U.S. Cl. CPC H02M 1/36; H02M 1/08; H02M 3/33523

(57) ABSTRACT

A semiconductor device includes: a first external terminal configured to be capable of connecting to a second end of an input resistor having a first end to which an input voltage is capable of being applied; a clamp circuit configured to clamp a voltage at the first external terminal; an enhancement-type first element having a first main electrode, a second main electrode, and a control terminal connected to the first external terminal; a driver; a second element having a first main electrode connected to the second main electrode of the first element, and a control terminal configured to be driven by the driver; and a current control circuit connected between the second main electrode of the first element and a power supply capacitor.

### CROSS-REFERENCE TO RELATED APPLICATION

This application is based upon and claims the benefit of priority from Japanese Patent Application No. 2025-051584, filed on Mar. 26, 2025, the entire contents of which are incorporated herein by reference.

### TECHNICAL FIELD

The present disclosure relates to a semiconductor device.

### BACKGROUND

Conventionally, it is known that a control circuit for use in an AC/DC converter includes a startup circuit. The startup circuit is used to charge a capacitor, which is connected to a power supply terminal to which a power supply voltage of the control circuit is applied, at the time of startup when an AC voltage starts to be input.

### BRIEF DESCRIPTION OF DRAWINGS

The accompanying drawings, which are incorporated in and constitute a part of the specification, illustrate embodiments of the present disclosure.

FIG. 1 is a diagram illustrating a configuration of an isolated DC/DC converter according to an exemplary embodiment of the present disclosure.

FIG. 2A is a diagram illustrating an example of an internal configuration of a semiconductor device.

FIG. 2B is a diagram illustrating another example of the internal configuration of the semiconductor device.

FIG. 2C is a waveform diagram for explaining sampling timing by a sample-and-hold circuit.

FIG. 3 is a diagram illustrating an example of a configuration of a current control circuit.

FIG. 4 is a timing chart illustrating an example of an operation of the semiconductor device.

FIG. 5 is a diagram illustrating a configuration of a semiconductor device according to a modification.

FIG. 6 is a diagram illustrating an example of a plan view of the semiconductor device as viewed from above.

FIG. 7 is a diagram illustrating an example of a configuration of an AC/DC converter.

FIG. 8 is an external view illustrating an example of a configuration of a vehicle.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Hereinafter, exemplary embodiments of the present disclosure will be described with reference to the drawings.

### Isolated DC/DC Converter

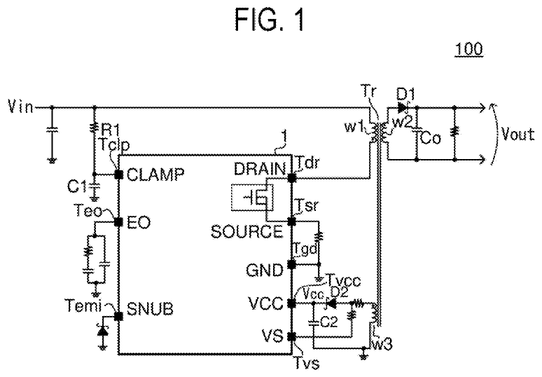

FIG. 1 is a diagram illustrating a configuration of an isolated DC/DC converter 100 according to an exemplary embodiment of the present disclosure. The isolated DC/DC converter 100 converts an input voltage Vin, which is a DC voltage, into an output voltage Vout, which is also a DC voltage, while electrically isolating the input voltage Vin from the output voltage Vout by a transformer Tr.

The isolated DC/DC converter 100 includes a semiconductor device 1, and an input resistor R1, an input capacitor C1, a power supply capacitor C2, diodes D1 and D2, an output capacitor Co, and the transformer Tr, which are provided discretely outside the semiconductor device 1. A rectifying-and-smoothing circuit is constituted by the diode D1 and the output capacitor Co.

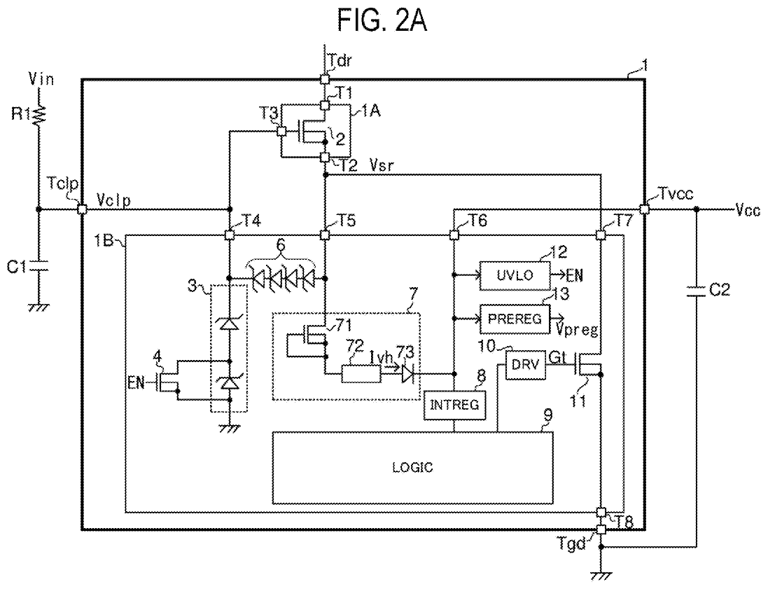

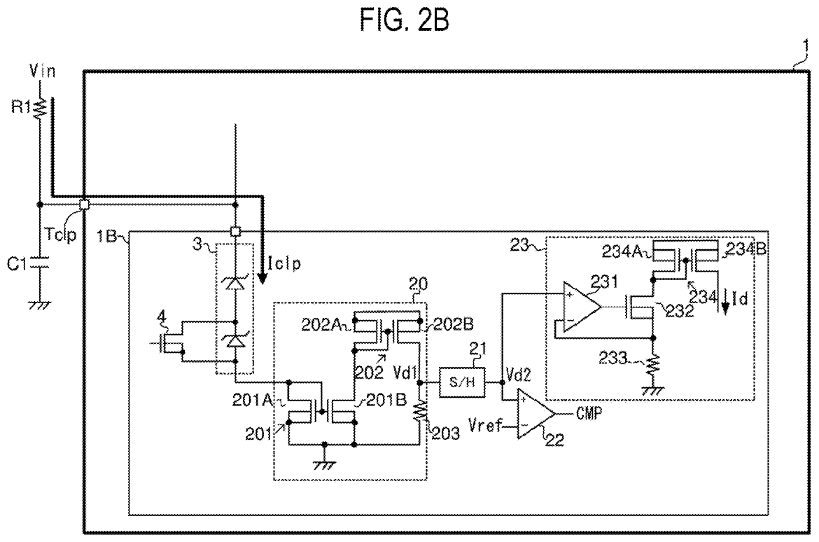

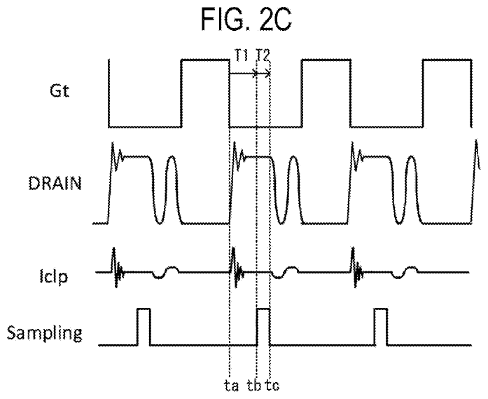

The semiconductor device 1 is a power integrated circuit (IC) in which an internal configuration illustrated in FIG. 2A, which will be described later, is integrated and packaged. The semiconductor device 1 includes, as external terminals for establishing electrical connection with external components, a clamp terminal Tclp, an EO terminal Teo, an EMI reduction terminal Temi, a drain terminal Tdr, a source terminal Tsr, a ground terminal Tgd, a power supply terminal Tvcc, and a sense terminal Tvs.

The transformer Tr includes a primary winding w1, a secondary winding w2, and an auxiliary winding w3. An application terminal of the input voltage Vin is connected to one end of the primary winding w1. The other end of the primary winding w1 is connected to the drain terminal Tdr. One end of the secondary winding w2 is connected to an anode of the diode D1. A cathode of the diode D1 is connected to one end of the output capacitor Co. The other end of the output capacitor Co is connected to the other end of the secondary winding w2. The output voltage Vout is generated across both ends of the output capacitor Co.

One end of the auxiliary winding w3 is connected to an anode of the diode D2. A cathode of the diode D2 is connected to one end of the power supply capacitor C2 and also connected to the power supply terminal Tvcc. The other end of the auxiliary winding w3 and the other end of the power supply capacitor C2 are connected to an application terminal of ground potential.

The input resistor R1 and the input capacitor C1 will be described later.

### Internal Configuration of Semiconductor Device

FIG. 2A is a diagram illustrating the internal configuration of the semiconductor device 1. In FIG. 2A, characteristic configurations of the present disclosure inside the semiconductor device 1 are selectively illustrated, while other internal configurations are omitted from the illustration.

As illustrated in FIG. 2A, the semiconductor device 1 includes a chip 1A and a chip 1B. That is, the semiconductor device 1 has a multi-chip configuration.

In the chip 1A, a first element 2 is integrated. The first element (first transistor) 2 is constituted by an enhancement-type N-channel metal-oxide-semiconductor field-effect transistor (MOSFET). The chip 1A includes electrodes T1 to T3. A drain of the first element 2 is connected to the drain terminal Tdr via the electrode T1.

The application terminal of the input voltage Vin is connected to one end of the input resistor R1. The other end of the input resistor R1 and one end of the input capacitor C1 are connected to the clamp terminal Tclp. The other end of the input capacitor C1 is connected to the application terminal of ground potential. The input capacitor C1 is provided to stabilize a terminal voltage Vclp of the clamp terminal Tclp, but is not essential.

The clamp terminal Tclp is connected to a gate of the first element 2 via the electrode T3. Accordingly, the terminal voltage Vclp is applied to the gate of the first element 2.

In the chip 1B, a clamp circuit 3, a switch 4, a protection part 6, a current control circuit 7, an internal regulator 8, a logic part 9, a driver 10, a second element (second transistor) 11, an under-voltage lock-out (UVLO) part 12, and a pre-regulator 13 are integrated. In addition, the chip 1B includes electrodes T4 to T8.

The clamp circuit 3 is a circuit for clamping the terminal voltage Vclp, and is constituted by Zener diodes connected in series. A cathode of a Zener diode on a highest potential side is connected to the clamp terminal Tclp via the electrode T4, and an anode of a Zener diode on a lowest potential side is connected to the application terminal of ground potential. Further, the number of Zener diodes constituting the clamp circuit 3 is not particularly limited as long as it is one or more.

The switch 4 is connected across both ends of a part of the Zener diodes constituting the clamp circuit 3. The switch 4 is controlled to be turned on and turned off by an enable signal EN. When the switch 4 is turned on, the part of the Zener diodes is bypassed, and a clamp voltage by the clamp circuit 3 is reduced.

A source of the first element 2 is connected to the electrode T5 via the electrode T2. The protection part 6 is connected between the electrode T5 and one end of the electrode T4. The protection part 6 is constituted by Zener diodes connected in series. An anode of the Zener diodes is connected to the electrode T5, and a cathode thereof is connected to the electrode T4. Voltage clamping by the protection part 6 protects against a withstand voltage of a Vgs (gate-source voltage) of the first element 2.

The current control circuit 7 is connected between the electrodes T5 and T6. The electrode T6 is connected to one end of the power supply capacitor C2 via the power supply terminal Tvcc. The current control circuit 7 controls a charging current Ivh that flows to charge the power supply capacitor C2 at a startup when application of the input voltage Vin is started. A specific configuration of the current control circuit 7 will be described later.

The internal regulator 8 is a power supply circuit that performs DC/DC conversion on a power supply voltage Vcc applied to the power supply terminal Tvcc and supplies the converted voltage to the logic part 9.

The second element 11 is constituted by an N-channel MOSFET and functions as a switching element. A drain of the second element 11 is connected to the source of the first element 2 via the electrodes T7 and T2. A source of the second element 11 is connected to the ground terminal Tgd via the electrode T8. The ground terminal Tgd is connected to the application terminal of the ground potential.

The driver 10 drives the second element 11 by applying a gate voltage Gt to a gate of the second element 11 under control of the logic part 9. When the gate voltage Gt is set to a high level, the second element 11 is turned on, and when the gate voltage Gt is set to a low level, the second element 11 is turned off. By switching-driving the second element 11, energy is transferred from the primary side to the secondary side of the transformer Tr.

The UVLO part 12 monitors the power supply voltage Vcc to detect a UVLO state or a UVLO release state. When the power supply voltage Vcc is equal to or lower than a predetermined UVLO release voltage, the UVLO state is detected, and when the power supply voltage Vcc exceeds the UVLO release voltage, the UVLO release state is detected. The UVLO part 12 outputs the enable signal EN indicating the UVLO state or the UVLO release state.

The pre-regulator 13 outputs the power supply voltage Vcc as a regulator output Vpreg when the input power supply voltage Vcc is lower than a predetermined voltage, and outputs the predetermined voltage as the regulator output Vpreg when the input power supply voltage Vcc is equal to or higher than the predetermined voltage. The regulator output Vpreg is used for control in the current control circuit 7, as will be described later.

### Configuration of Current Control Circuit

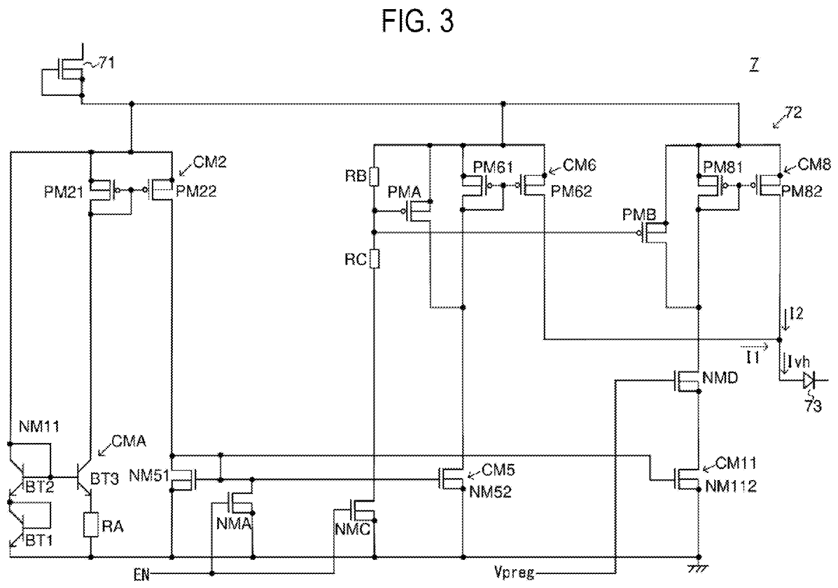

FIG. 3 is a diagram illustrating an example of a configuration of the current control circuit 7. The current control circuit 7 includes a depletion MOS transistor 71, a constant current circuit 72, and a reverse current prevention diode 73.

The depletion MOS transistor 71 is constituted by a depletion-type N-channel MOSFET. A drain of the depletion MOS transistor 71 is connected to the electrode T5 (see FIG. 2A). A gate and a source of the depletion MOS transistor 71 are connected together. Accordingly, the depletion MOS transistor 71 operates as a constant current source.

The constant current circuit 72 is connected between the source of the depletion MOS transistor 71 and an anode of the reverse current prevention diode 73. The constant current circuit 72 includes an NPN transistor (bipolar transistor) BT1, resistors RA to RC, a current mirror CMA, current mirrors CM2, CM5, CM6, CM8, and CM11, NMOS transistors NMA, NMC, and NMD, and PMOS transistors PMA and PMB. Further, the NMOS transistor is an N-channel MOSFET, and the PMOS transistor is a P-channel MOSFET.

An emitter of the NPN transistor BT1 is connected to the application terminal of ground potential. A base and a collector of the NPN transistor BT1 are connected together. The current mirror CMA includes NPN transistors BT2 and BT3. The collector of the NPN transistor BT1 is connected to an emitter of the NPN transistor BT2. A base and a collector of the NPN transistor BT2 are connected together. Bases of the NPN transistors BT2 and BT3 are connected to each other. An emitter of the NPN transistor BT3 is connected to one end of the resistor RA. The other end of the resistor RA is connected to the application terminal of ground potential. The collector of the NPN transistor BT2 is connected to the source of the depletion MOS transistor 71.

The current mirror CM2 includes PMOS transistors PM21 and PM22. Sources of the PMOS transistors PM21 and PM22 are connected to the source of the depletion MOS transistor 71. A gate and a drain of the PMOS transistor PM21 are connected together. Gates of the PMOS transistors PM21 and PM22 are connected to each other.

The current mirror CM5 includes NMOS transistors NM51 and NM52. A drain of the NMOS transistor NM51 is connected to a drain of the PMOS transistor PM22. A gate and a drain of the NMOS transistor NM51 are connected together. Gates of the NMOS transistors NM51 and NM52 are connected to each other. A source of the NMOS transistor NM51 is connected to the application terminal of ground potential.

A source of the NMOS transistor NM52 is connected to the application terminal of ground potential.

The current mirror CM6 includes PMOS transistors PM61 and PM62. Sources of the PMOS transistors PM61 and PM62 are connected to the source of the depletion MOS transistor 71. A gate and a drain of the PMOS transistor PM61 are connected together. Gates of the PMOS transistors PM61 and PM62 are connected to each other. A drain of the PMOS transistor PM61 is connected to a drain of the NMOS transistor NM52.

The current mirror CM8 includes PMOS transistors PM81 and PM82. Sources of the PMOS transistors PM81 and PM82 are connected to the source of the depletion MOS transistor 71. A gate and a drain of the PMOS transistor PM81 are connected together. Gates of the PMOS transistors PM81 and PM82 are connected to each other.

A drain of the PMOS transistor PM82 and a drain of the PMOS transistor PM62 are connected to the anode of the reverse current prevention diode 73.

A drain of the NMOS transistor NMA is connected to the gates of the NMOS transistors NM51 and NM52. A source of the NMOS transistor NMA is connected to the application terminal of ground potential.

A source of the NMOS transistor NMC is connected to the application terminal of ground potential. Resistors RB and RC are connected in series between the source of the depletion MOS transistor 71 and a drain of the NMOS transistor NMC. Gates of the PMOS transistors PMA and PMB are connected to a node to which the resistors RB and RC are connected.

A source of the PMOS transistor PMA is connected to the source of the PMOS transistor PM61. A drain of the PMOS transistor PMA is connected to the drain of the PMOS transistor PM61. A source of the PMOS transistor PMB is connected to the source of the PMOS transistor PM81. A drain of the PMOS transistor PMB is connected to a drain of the PMOS transistor PM81.

The enable signal EN is applied to gates of the NMOS transistors NMA and NMC.

The current mirror CM11 includes the NMOS transistor NM51 and an NMOS transistor NM112. That is, the current mirrors CM11 and CM5 share the NMOS transistor NM51.

A drain of the NMOS transistor NMD is connected to the drain of the PMOS transistor PM81. A source of the NMOS transistor NMD is connected to a drain of the NMOS transistor NM112. A source of the NMOS transistor NM112 is connected to the application terminal of ground potential. The regulator output Vpreg is applied to a gate of the NMOS transistor NMD.

According to the constant current circuit 72 having the configuration described above, a bandgap current source is constituted by the NPN transistors BT1, BT2, and BT3 and the resistor RA. Since a forward voltage VF generated by BT1 and BT2 is equal to VF+RA×Iout (where Iout is an output current flowing through the resistor RA) generated by BT3, temperature characteristics of the forward voltage VF and the resistor RA are combined to flatten temperature characteristics of the output current. Further, an amount of constant current generated by the constant current circuit 72 is adjusted by a current mirror. Since semiconductor elements have excellent matching characteristics, accuracy of an absolute value of the constant current is improved.

### Operation of Semiconductor Device

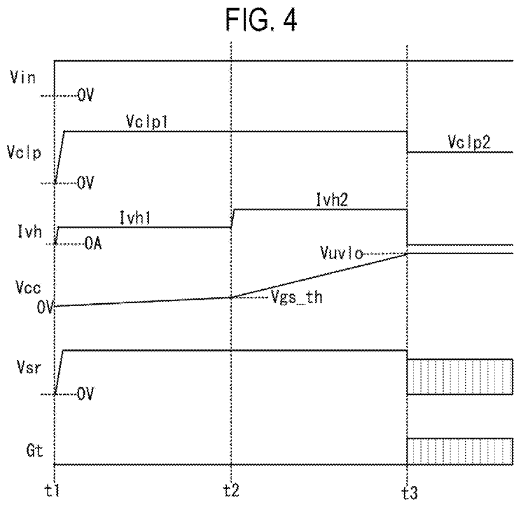

Next, an operation of the semiconductor device 1 having the configuration described above will be described with reference to a timing chart shown in FIG. 4. In FIG. 4, examples of waveforms of the input voltage Vin, the terminal voltage Vclp of the clamp terminal Tclp, the charging current Ivh generated by the current control circuit 7, the power supply voltage Vcc, a source voltage Vsr of the first element 2, and the gate voltage Gt are illustrated sequentially from top.

First, when application of the input voltage Vin is started at timing t1, a startup operation is initiated. At this time, due to charging of the input capacitor C1, the terminal voltage Vclp immediately rises to a clamp voltage Vclp1. Since the UVLO state is detected by the UVLO part 12, the enable signal EN becomes a low level and the switch 4 is turned off. As a result, the terminal voltage Vclp is clamped to the clamp voltage Vclp1 by the clamp circuit 3. The clamp voltage Vclp1 is applied to the gate of the first element 2, whereby the first element 2 is in a conductive state and the source voltage Vsr becomes lower than the clamp voltage Vclp1 by Vgs of the first element 2. For example, when the clamp voltage Vclp1=30 V and Vgs of the first element 2=3 V, the source voltage Vsr becomes 27 V.

When the source voltage Vsr is applied to the current control circuit 7, generation of the charging current Ivh is started. In the current control circuit 7 shown in FIG. 3, the enable signal EN is at a low level. Accordingly, the NMOS transistor NMA is turned off and the current mirror CM5 is enabled.

The NMOS transistor NMC is also turned off, the PMOS transistor PMA is turned off, and the current mirror CM6 is enabled. On the other hand, since the regulator output Vpreg is lower than a threshold Vgs_th (e.g., 2 V) of Vgs of the NMOS transistor NMD, the NMOS transistor NMD is turned off. As a result, the PMOS transistor PMB is turned off and the current mirror CM8 is disabled.

Therefore, a constant current flowing through the resistor RA is mirrored by the current mirrors CM2, CM5, and CM6, and a current I1 output from the drain of the PMOS transistor PM62 is generated. A current I2 output from the drain of the PMOS transistor PM82 is not generated. The charging current Ivh is generated by combining the currents I1 and I2. However, since the current I2 is not generated, the current I1 is output as the charging current Ivh. When the charging current Ivh at this time is denoted as Ivh1, for example, Ivh1 is 480 μA.

By supplying the charging current Ivh (Ivh1) to the power supply capacitor C2, the power supply capacitor C2 is charged and the power supply voltage Vcc increases gradually.

Further, when the power supply voltage Vcc exceeds the threshold Vgs_th of the Vgs of the NMOS transistor NMD at timing t2, the regulator output Vpreg also exceeds the threshold Vgs_th, so that the NMOS transistor NMD is turned on (i.e., switched from an off state to an on state) and the current mirror CM8 is enabled. As a result, the current flowing through the resistor RA is mirrored by the current mirrors CM2, CM11, and CM8, and the current I2 is generated. Accordingly, the charging current Ivh is output as a sum of the currents I1 and I2. When the charging current Ivh at this time is denoted as Ivh2, for example, Ivh2=1.3 mA.

The reason for setting the charging current Ivh first to a lower value Ivh1 and then to a higher value Ivh2 as described above is that when the power supply terminal Tvcc is grounded, the power supply voltage Vcc will be fixed at 0 V, and loss caused by the charging current Ivh will become problematic. In particular, when the input voltage Vin is a high voltage, for example, about 1,000 V, the resulting loss becomes especially problematic. Further, once the power supply voltage Vcc rises to a certain level, since no ground fault exists, the charging current Ivh is switched to a higher value to shorten a startup time.

When the power supply voltage Vcc further rises due to charging by the charging current Ivh (Ivh2) and reaches a UVLO release voltage Vuvlo, release of UVLO is detected by the UVLO part 12. At this time, the enable signal EN switches from a low level to a high level, the NMOS transistor NMA is turned on, and the current mirror CM5 is disabled. Further, since the NMOS transistor NMC is also turned on, the PMOS transistors PMA and PMB are turned on, and the current mirrors CM6 and CM8 are disabled. As a result, the currents I1 and I2 are no longer generated, and output of the charging current Ivh is stopped. At this time, in the current control circuit 7, a current flowing through the NPN transistor BT1 and the resistor RA becomes a standby current, and the standby current can be reduced significantly.

Since the enable signal EN is at a high level, the switch 4 is turned on, and the terminal voltage Vclp becomes a clamp voltage Vclp2 lower than the clamp voltage Vclp1. For example, when Vclp1 is 30 V, Vclp2 is 20 V. On the other hand, upon release of UVLO, switching drive of the second element 11 by the driver 10 under control of the logic part 9 is started (gate voltage Gt in FIG. 4). Thus, the startup operation is completed, and power conversion via the transformer Tr is started.

The reason for switching the clamp voltage by the switch 4 in the clamp circuit 3 is that a voltage value required to be applied to the gate of the first element 2 differs between the time of startup and the time of switching. Specifically, during the startup, when Vcc reaches the UVLO release voltage Vuvlo, the clamp voltage Vclp1 is set to a voltage value (e.g., 30 V) with a sufficient margin relative to a voltage value (e.g., 23 V) obtained by adding a forward voltage of the reverse current prevention diode 73, Vds (drain-to-source voltage) of the PMOS transistor PM62 or PM82, Vds of the depletion MOS transistor 71, and Vgs of the first element 2 to the power supply voltage Vcc. On the other hand, during the switching, since the source voltage Vsr becomes 0 V when the second element 11 is turned on, and considering a Vgs withstand voltage (e.g., 26 V) of the first element 2, the clamp voltage Vclp2 is set to a voltage value (e.g., 20 V) that can fully turn on the first element 2.

With the embodiment described above, the first element 2 can be shared between the time of startup and the time of switching, so that it is unnecessary to separately provide an element for startup, thereby reducing the number of components. Further, a semiconductor material for use in the first element 2 can be changed according to a value of the input voltage Vin. For example, when the input voltage Vin is a high voltage such as 1,000 V, SiC or GaN can be used as the semiconductor material, whereas when the input voltage Vin is about 400 V, Si can be used as the semiconductor material. In addition, only the input resistor R1 and the input capacitor C1 need to be provided externally for the clamp terminal Tclp, thereby reducing the number of components and reducing an area of a substrate on which the semiconductor device is mounted, as compared with a case in which a startup circuit for stepping down an input voltage is configured outside the semiconductor device.

In the current control circuit 7 (see FIG. 3), the depletion MOS transistor 71 and the constant current circuit 72 are used. Since the depletion MOS transistor 71 tends to have large variations in constant current characteristics, the depletion MOS transistor 71 is designed to have sufficient current capability (e.g., 5 mA) by adjusting a gate width and a gate length, and constant current accuracy is improved by the constant current circuit 72. As a result, constant current accuracy of the charging current Ivh is enhanced and variation in startup time is suppressed. Further, the depletion MOS transistor may be omitted. However, by providing the depletion MOS transistor, an unstable current during switching can be suppressed. Alternatively, only the depletion MOS transistor may be provided as a constant current source.

### Modification

FIG. 2B is a diagram illustrating a modification of the configuration of the chip 1B in the semiconductor device 1. In FIG. 2B, a configuration connected to the anode of the Zener diode on the lowest potential side in the clamp circuit 3 differs from that in FIG. 2A. Further, other configurations of the chip 1B not illustrated in FIG. 2B are the same as those in FIG. 2A.

The chip 1B in FIG. 2B includes an I-V (current-to-voltage) converter 20, a sample-and-hold circuit 21, a comparator 22, and a V-I (voltage-to-current) converter 23.

The I-V converter 20 includes current mirrors 201 and 202 and a conversion resistor 203. The current mirror 201 includes NMOS transistors 201A and 201B. A drain of the NMOS transistor 201A is connected to the anode of the Zener diode on the lowest potential side in the clamp circuit 3. A gate and a drain of the NMOS transistor 201A are connected together. Gates of the NMOS transistors 201A and 201B are connected to each other. Sources of the NMOS transistors 201A and 201B are connected to the application terminal of ground potential. The current mirror 202 includes PMOS transistors 202A and 202B. A drain of the PMOS transistor 202A is connected to the drain of the NMOS transistor 201B. A gate and a drain of the PMOS transistor 202A are connected together. Gates of the PMOS transistors 202A and 202B are connected to each other. A source of the PMOS transistor 202B is connected to one end of the conversion resistor 203. The other end of the conversion resistor 203 is connected to the application terminal of ground potential.

With the configuration of the I-V converter 20 described above, a current Iclp flowing from the application terminal of the input voltage Vin through the input resistor R1, the clamp terminal Tclp, and the clamp circuit 3 is mirrored sequentially by the current mirrors 201 and 202, and is converted into a detection voltage Vd1 by the conversion resistor 203.

The sample-and-hold circuit 21 performs sampling and holding with respect to the detection voltage Vd1. Since the clamp terminal Tclp is a high-impedance terminal, the sample-and-hold circuit 21 is provided in order to suppress influence of switching noise caused by switching of the second element 11 (not shown in FIG. 2B).

FIG. 2C is a waveform diagram for explaining sampling timing by the sample-and-hold circuit 21. In FIG. 2C, the gate voltage Gt, a drain voltage DRAIN of the second element 11, the current Iclp, and a sampling state are shown sequentially from top.

At timing ta when the gate voltage Gt is switched from a high level to a low level, the second element 11 is turned off and the drain voltage DRAIN rises. Immediately thereafter, the drain voltage DRAIN fluctuates, and the current Iclp also fluctuates. At timing tb when a predetermined time T1 has elapsed from timing ta, the fluctuations of the drain voltage DRAIN and the current Iclp have settled, and sampling is started at this timing (that is, holding is released). Further, the sampling is performed until timing tc when a predetermined time T2 has elapsed, and at timing tc, the sampling ends and holding is performed. During a period between timing tb and timing tc, the drain voltage DRAIN and the current Iclp are stable, and the sampling can be performed in a state in which influence of switching noise is suppressed.

As a result of the sampling and holding by the sample-and-hold circuit 21, a detection voltage Vd2 is output. The detection voltage Vd2 is applied to a first input terminal of the comparator 22. A reference voltage Vref is applied to a second input terminal of the comparator 22. The comparator 22 compares the detection voltage Vd2 with the reference voltage Vref and outputs a comparison output CMP.

Here, the current Iclp is expressed by the following equation:

Iclp=(Vin−(Vz+Vgs))/R1,

where Vz is the Zener voltage of the clamp circuit 3, and Vgs is a gate-source voltage of the NMOS transistor 201A.

When a voltage at the clamp terminal Tclp is normal, the current Iclp expressed by the above equation is converted into the detection voltage Vd1 by the I-V converter 20, and the detection voltage Vd2 obtained by the sample-and-hold circuit 21 is applied to the comparator 22. In this case, the detection voltage Vd2 is equal to or higher than the reference voltage Vref, and the comparison output CMP becomes a corresponding logic level. By adjusting temperature characteristics of (Vz+Vgs) in the above equation, temperature characteristics of the current Iclp are flattened.

On the other hand, when the voltage at the clamp terminal Tclp decreases abnormally, the current Iclp increases and the detection voltage Vd2 becomes higher than the reference voltage Vref. The comparison output CMP becomes a corresponding logic level, and an abnormal state can be detected.

The V-I converter 23 includes an error amplifier 231, an NMOS transistor 232, a resistor 233, and a current mirror 234. A non-inverting input terminal of the error amplifier 231 is connected to an application terminal of the detection voltage Vd2. An output terminal of the error amplifier 231 is connected to a gate of the NMOS transistor 232. A source of the NMOS transistor 232 is connected to an inverting input terminal of the error amplifier 231 and one end of the resistor 233. The other end of the resistor 233 is connected to the application terminal of ground potential. The current mirror 234 includes PMOS transistors 234A and 234B. A drain of the PMOS transistor 234A is connected to a drain of the NMOS transistor 232. A gate and a drain of the PMOS transistor 234A are connected together. Gates of the PMOS transistors 234A and 234B are connected to each other. Sources of the PMOS transistors 234A and 234B are connected to each other.

With the configuration of the V-I converter 23 described above, the detection voltage Vd2 is generated at the one end of the resistor 233. Accordingly, a current corresponding to the detection voltage Vd2 flows through the resistor 233, is mirrored by the current mirror 234, and becomes a detection current Id. Since the current Iclp depends on the input voltage Vin as expressed by the above equation, the input voltage Vin can be detected based on the detection current Id. The detection current Id is used for controlling, for example, an overcurrent protection (OCP) voltage.

With the configuration of FIG. 2B described above, the clamp circuit 3 can be shared for detection of the current Iclp.

### Another Modification

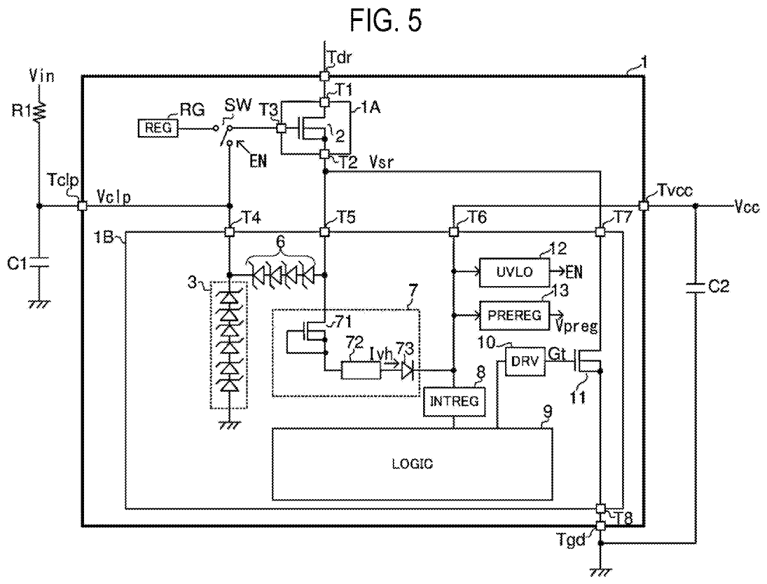

FIG. 5 is a diagram illustrating a configuration of the semiconductor device 1 according to another modification. A difference from the above-described configuration is that a switch SW and a gate drive regulator RG are provided. In this case, the switch 4 for switching the clamp voltage is unnecessary.

The switch SW switches between connection of the clamp terminal Tclp and the electrode T3, and connection of an output terminal of the gate drive regulator RG and the electrode T3. The switch SW is switched by the enable signal EN. When the enable signal EN is at a low level (UVLO state), the switch SW connects the clamp terminal Tclp and the electrode T3. As a result, the terminal voltage Vclp can be applied to the gate of the first element 2. On the other hand, when the enable signal EN is at a high level (UVLO release state), the switch SW connects the output terminal of the gate drive regulator RG and the electrode T3. As a result, the output voltage of the gate drive regulator RG can be applied to the gate of the first element 2 during switching, and the gate voltage of the first element 2 can be stabilized.

### Layout of External Terminals

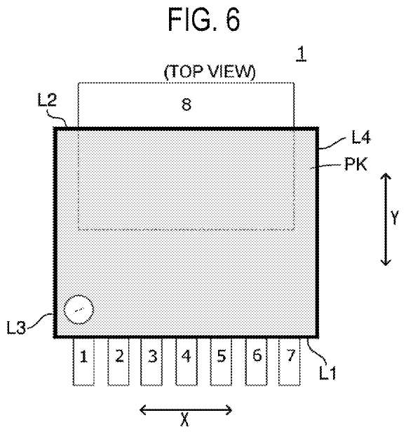

FIG. 6 illustrates an example of a plan view of the semiconductor device 1 as viewed from above. As illustrated in FIG. 6, in the semiconductor device 1, external terminals (pins 1 to 8) are connected to a package PK. Further, a first direction (X) and a second direction (Y) orthogonal to each other are illustrated in FIG. 6.

The package PK has a rectangular shape having sides L1 and L2 extending in the first direction and sides L3 and L4 extending in the second direction in a plan view. The sides L1 and L2 face each other in the second direction. The pins 1 to 8 are the power supply terminal Tvcc, the ground terminal Tgd, the EO terminal Teo, the sense terminal Tvs, the source terminal Tsr, the clamp terminal Tclp, the EMI reduction terminal Temi, and the drain terminal Tdr, sequentially in this order.

The pins 1 to 7 are disposed along the side L1 of the package PK in a plan view. The pin 8 is disposed on a back surface of the package PK and protrudes from the side L2 in the second direction in a plan view. The pin 8 is also used for heat dissipation.

### AC/DC Converter

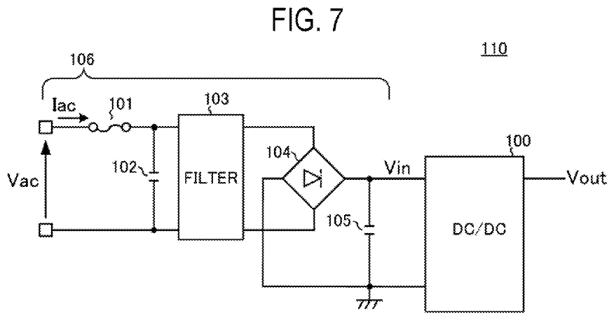

FIG. 7 is a diagram illustrating a configuration of an AC/DC converter 110 using the isolated DC/DC converter 100 according to the present embodiment. The AC/DC converter 110 includes an input circuit 106 and the isolated DC/DC converter 100. The input circuit 106 includes a fuse 101, a capacitor 102, a filter 103, a rectifier circuit 104, and a capacitor 105, and generates the input voltage Vin from an AC voltage Vac.

The rectifier circuit 104 is, for example, a diode bridge. The AC voltage Vac such as a commercial AC voltage is supplied to the rectifier circuit 104 via the fuse 101, the capacitor 102, and the filter 103. The rectifier circuit 104 performs full-wave rectification on the AC voltage Vac. The full-wave-rectified voltage is smoothed by the capacitor 105 to generate the input voltage Vin. The input voltage Vin is input to the isolated DC/DC converter 100. The isolated DC/DC converter 100 steps down the input voltage Vin and outputs the output voltage Vout. In the AC/DC converter described above, the input voltage Vin is, for example, about 400 V.

### Vehicle

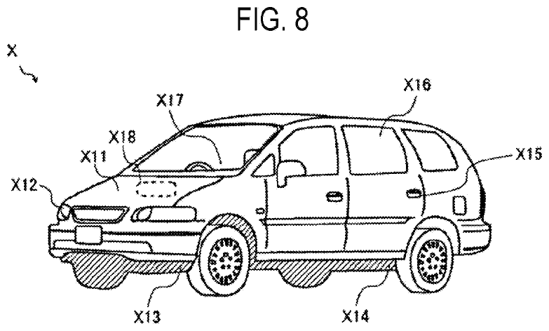

FIG. 8 is an external view illustrating an example of a configuration of a vehicle X. The vehicle X of this configuration example is equipped with various electronic devices X11 to X18 that operate by receiving power supplied from a battery (not shown). Further, installation positions of the electronic devices X11 to X18 in FIG. 8 may differ from actual positions for convenience of illustration.

The electronic device X11 is an engine control unit that performs control relating to an engine (such as injection control, electronic throttle control, idling control, oxygen sensor heater control, and auto-cruise control).

The electronic device X12 is a lamp control unit that performs on/off control of high-intensity discharge lamps (HIDs), daytime running lamps (DRLs), and the like.

The electronic device X13 is a transmission control unit that performs control relating to a transmission.

The electronic device X14 is a body control unit that performs control relating to motion of the vehicle X (such as anti-lock brake system (ABS) control, electric power steering (EPS) control, and electronic suspension control).

The electronic device X15 is a security control unit that performs drive control of a door lock, a security alarm, and the like.

The electronic device X16 includes electronic devices incorporated in the vehicle X at a factory shipment stage as standard equipment or manufacturer options, such as wipers, electric door mirrors, power windows, dampers (shock absorbers), an electric sunroof, and electric seats.

The electronic device X17 includes electronic devices optionally mounted on the vehicle X as user options, such as in-vehicle audio/visual (A/V) equipment, a car navigation system, and an electronic toll collection system (ETC).

The electronic device X18 includes electronic devices having high-withstand-voltage motors, such as an in-vehicle blower, an oil pump, a water pump, and a battery cooling fan.

The isolated DC/DC converter 100 including the semiconductor device 1 described above may be supplied with a high input voltage Vin of, for example, 1,000 V from a battery, and may be applied to any of the electronic devices X11 to X18.

### Others

Various technical features disclosed in this specification can be modified in various ways without departing from the spirit of the technical creation, in addition to the above-described embodiments. Accordingly, the above-described embodiments are to be considered in all respects as illustrative and not restrictive, and the technical scope of the present disclosure is not limited to the above-described embodiments but should be understood to include all modifications that fall within the meaning and scope equivalent to the claims.

### Supplementary Notes

As described above, a semiconductor device (1) according to one embodiment of the present disclosure has a configuration (first configuration) that includes:
a first external terminal (Tclp) configured to be capable of connecting to a second end of an input resistor (R1) having a first end to which an input voltage (Vin) is capable of being applied;
a clamp circuit (3) configured to clamp a voltage at the first external terminal;
an enhancement-type first element (2) having a first main electrode (drain), a second main electrode (source), and a control terminal (gate) connected to the first external terminal;
a driver (10);
a second element (11) having a first main electrode (drain) connected to the second main electrode of the first element, and a control terminal (gate) configured to be driven by the driver; and
a current control circuit (7) connected between the second main electrode of the first element and a power supply capacitor (C2),
wherein, at a time of startup when application of the input voltage is started, the power supply capacitor is charged by a charging current (Ivh) output from the current control circuit, and
wherein, when a power supply voltage (Vcc) rises due to the charging of the power supply capacitor and reaches an under-voltage lock-out (UVLO) release voltage, generation of the charging current by the current control circuit is stopped, the first element is in a conductive state, and the driver starts switching drive of the second element.

According to the first configuration, since the first element is shared between a startup operation and a switching operation, the number of components can be reduced. Further, the number of elements connected to the first external terminal can be reduced, thereby reducing an area of a substrate on which the semiconductor device is mounted. Furthermore, when the power supply voltage reaches the UVLO release voltage, the charging current is stopped, thereby suppressing a standby current.

The semiconductor device (1) of the first configuration may have a configuration (second configuration) that an input capacitor (C1) connected to the second end of the input resistor and the second element are capable of being connected to the first external terminal.

The semiconductor device (1) of the first or second configuration may have a configuration (third configuration) that a clamp voltage generated by the clamp circuit is switchable according to a UVLO state or a UVLO release state.

The semiconductor device (1) of the third configuration may have a configuration (fourth configuration) that the clamp circuit is configured by Zener diodes connected in series, and the semiconductor device further includes a switch configured to be connected across both ends of a part of the Zener diodes.

The semiconductor device (1) of any one of the first to fourth configurations may have a configuration (fifth configuration) that the current control circuit includes at least one of a depletion MOS transistor (71) configured as a depletion-type N-channel MOSFET having a gate and a source connected together, or a constant current circuit (72) connected to the depletion MOS transistor.

The semiconductor device (1) of the fifth configuration may have a configuration (sixth configuration) that the constant current circuit outputs a first current (I1) as the charging current when the power supply voltage is lower than a threshold (Vgs_th), and outputs, as the charging current, a sum of the first current and a second current (I2) when the power supply voltage is equal to or higher than the threshold.

The semiconductor device (1) of any one of the first to sixth configurations may have a configuration (seventh configuration) that further includes: a regulator (RG) configured to apply an output to the control terminal of the first element, and, when a UVLO state transitions to a UVLO release state, a voltage (Vclp) applied to the control terminal of the first element is switched from the voltage at the first external terminal to the output of the regulator.

The semiconductor device (1) of any one of the first to seventh configurations may have a configuration (eighth configuration) that the first element is configured as an N-channel MOSFET including SiC or GaN as a semiconductor material.

An isolated DC/DC converter (100) according to one embodiment of the present disclosure has a configuration (ninth configuration) that includes:
the semiconductor device (1) of any one of the first to eighth configurations;
a transformer (Tr) including a primary winding (w1) connected between an application terminal of the input voltage and the first main electrode of the first element, a secondary winding (w2), and an auxiliary winding (w3);
a rectifying-and-smoothing circuit (D1, Co) connected to the secondary winding; and
a diode (D2) connected between the auxiliary winding and the power supply capacitor.

An AC/DC converter (110) according to one embodiment of the present disclosure has a configuration (tenth configuration) that includes: the isolated DC/DC converter of the ninth configuration; and an input circuit (106) configured to generate the input voltage from an AC voltage (Vac).

A vehicle (X) according to one embodiment of the present disclosure has a configuration (eleventh configuration) that includes:
the isolated DC/DC converter of the ninth configuration; and
a battery configured to output the input voltage.

### INDUSTRIAL APPLICABILITY

The present disclosure can be applied to, for example, an isolated DC/DC converter, an AC/DC converter, and the like.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A semiconductor device comprising:
a first external terminal configured to be capable of connecting to a second end of an input resistor having a first end to which an input voltage is capable of being applied;
a clamp circuit configured to clamp a voltage at the first external terminal;
an enhancement-type first element having a first main electrode, a second main electrode, and a control terminal connected to the first external terminal;
a driver;
a second element having a first main electrode connected to the second main electrode of the first element, and a control terminal configured to be driven by the driver; and
a current control circuit connected between the second main electrode of the first element and a power supply capacitor,
wherein at a time of startup when application of the input voltage is started, the power supply capacitor is charged by a charging current output from the current control circuit, and
wherein when a power supply voltage rises due to the charging of the power supply capacitor and reaches an under-voltage lock-out (UVLO) release voltage, generation of the charging current by the current control circuit is stopped, the first element is in a conductive state, and the driver starts switching drive of the second element.

2. The semiconductor device of claim 1, wherein an input capacitor connected to the second end of the input resistor and the second element are capable of being connected to the first external terminal.

3. The semiconductor device of claim 1, wherein a clamp voltage generated by the clamp circuit is switchable according to a UVLO state or a UVLO release state.

4. The semiconductor device of claim 3, wherein the clamp circuit is configured by Zener diodes connected in series,
wherein the semiconductor device further comprises a switch configured to be connected across both ends of a part of the Zener diodes, and
wherein the switch is turned on or turned off according to the UVLO state or the UVLO release state.

5. The semiconductor device of claim 1, wherein the current control circuit includes at least one of a depletion metal-oxide-semiconductor (MOS) transistor configured as a depletion-type N-channel metal-oxide-semiconductor field-effect transistor (MOSFET) having a gate and a source connected together, or a constant current circuit connected to the depletion MOS transistor.

6. The semiconductor device of claim 5, wherein the constant current circuit outputs a first current as the charging current when the power supply voltage is lower than a threshold, and outputs, as the charging current, a sum of the first current and a second current when the power supply voltage is equal to or higher than the threshold.

7. The semiconductor device of claim 1, further comprising a regulator configured to apply an output to the control terminal of the first element,
wherein when a UVLO state transitions to a UVLO release state, a voltage applied to the control terminal of the first element is switched from the voltage at the first external terminal to the output of the regulator.

8. The semiconductor device of claim 1, wherein the first element is configured as an N-channel metal-oxide-semiconductor field-effect transistor (MOSFET) including SiC or GaN as a semiconductor material.

9. An isolated DC/DC converter comprising:
the semiconductor device of claim 1;
a transformer including a primary winding connected between an application terminal of the input voltage and the first main electrode of the first element, a secondary winding, and an auxiliary winding;
a rectifying-and-smoothing circuit connected to the secondary winding; and
a diode connected between the auxiliary winding and the power supply capacitor.

10. An AC/DC converter comprising:
the isolated DC/DC converter of claim 9; and
an input circuit configured to generate the input voltage from an AC voltage.

11. A vehicle comprising:
the isolated DC/DC converter of claim 9; and
a battery configured to output the input voltage.
